(19) United States
(12) Patent Application Publication
(10) Pub. No.: US 2009/0174562 A1
(43) Pub. Date: Jul. 9, 2009

(54) Smoke detector battery tester triggered by any infrared remote

(76) Inventors: William E. Jacobus, Woodbury, MN (US); Benjamin W. Jacobus, Woodbury, MN (US)

Correspondence Address: William E. Jacobus, 3279 Churchill Drive, Woodbury, MN, 55125, US

(21) Appl. No.: 12/317,950

(22) Filed: Jan. 2, 2009

Related U.S. Application Data
(60) Provisional application No. 61/010,203, filed on Jan. 7, 2008.

(51) Int. Cl. G08B 21/00; H04B 10/00

(52) U.S. Cl. 340/636.1; 398/113

(57) ABSTRACT

The user may perform a smoke detector battery capacity test via an infrared (IR) trigger from a remote controller. When the proper amount of directed infrared energy (sourced by an infrared remote control device) is detected at the smoke detector the smoke detector runs the battery life test. The result of the battery test is displayed on a visual indicator on the smoke detector unit.

### BACKGROUND OF THE INVENTION

In present day the smoke detector is a household ubiquitous device. Proper operation of this device requires a battery with sufficient voltage and amperage capacity for proper operation of the aforementioned detector. The battery may be the primary energy source for the smoke detector or it may function as power backup for direct electrically wired units. In either case a health battery is critical for proper operation.

Another ubiquitous household device is the infrared remote control. These controllers are designed and sold with most household electronic audio and visual products which include Television, DVD, VCR, and Stereo remotes. This hand held remote controller triggers the corresponding infrared receiver (in the smoke detector unit) by supplying pulses of infrared energy which is sensed at the smoke detector receiver.

The present invention is able to detect infrared energy from any remote control and at that time perform a battery capacity test. This battery capacity test places a momentary electrical load on the battery and measures battery voltage. The Control Unit within this apparatus then determines the amount of battery life remaining. This has many advantages over the current method of smoke detector battery tests which will only send a visual and/or audible alarm when the battery is reaching low voltage, or simply tests for a healthy battery only when the test button is activated. One of the current methods requires the user to physically reach the device to test the battery by pushing a button on the device which is most times out of reach. The result is then simply a test of the unit without indication of how much longer the battery may last. An alternate present day method is to scan the current voltage of the battery and send an audible alarm (which is sometimes difficult to locate with many detectors in the house) which could come at times (such as in the night) when the user rather not hear it.

### SUMMARY OF THE INVENTION

The present invention relates to a directed smoke detector battery capacity (or life remaining) test triggered by any infrared remote. The invented apparatus is able to detect infrared energy from any pre-manufactured infrared remote control. Alternately this apparatus can be set to decode specific infrared pulses for use with a transmitting remote control specifically designed for this task.

The apparatus will then trigger the battery test circuit. After conclusion of the battery test this apparatus will provide visual information as to the state of the battery indicating if the battery should be scheduled for replacement.

This apparatus has been alternately used for Carbon Monoxide detectors.

### DESCRIPTION OF THE DRAWINGS

FIG. 1 shows the block diagram of the IR Triggered Smoke Detector Battery Tester. The block diagram within the dashed box are the components described in this apparatus.

### DETAILED DESCRIPTION

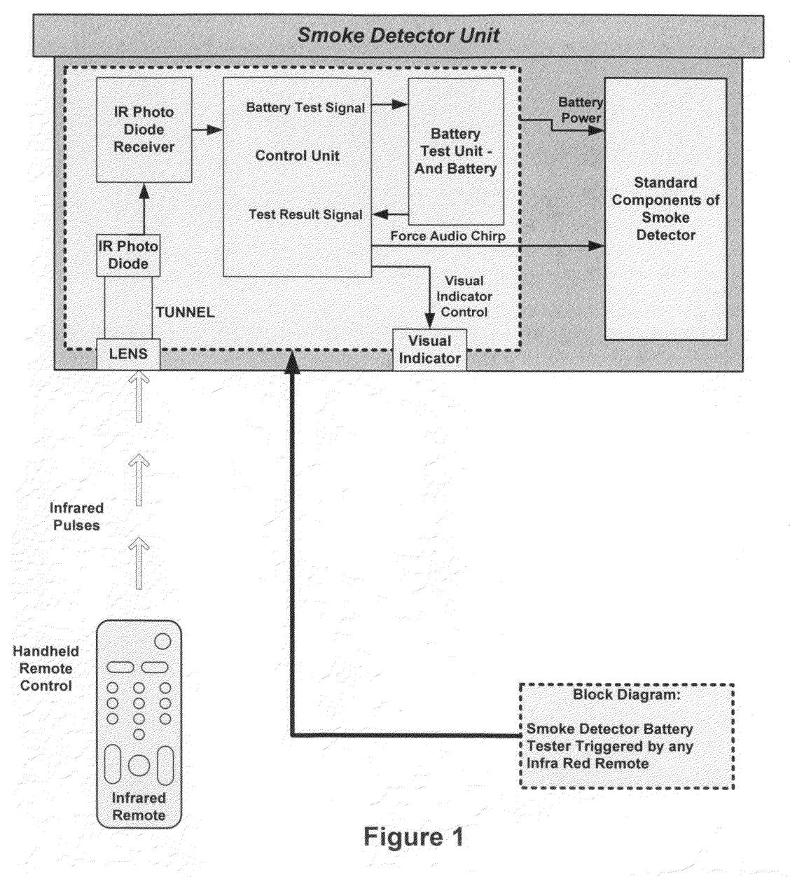

The dashed box within FIG. 1 shows a block diagram and flow of the present invention. As stated in the summary this present invention relates to a directed smoke detector battery test triggered by any infrared remote.

Since this apparatus has the ability to detect IR energy from any remote it employs a small lens and short tunnel for the IR pulses to travel through. This requires the user to point the remote directly at the smoke detector. This will prevent any erroneous triggering from the everyday use of the remote controllers' intended application. An alternate embodiment this could do without the Lens/Tunnel combination if the intensity of the IR transmitter is low or if the IR receiver is set to a high trigger level. Some combination of IR attenuation is required if off-the-shelf remotes (such as a TV remote) is used. Standard use of controlling the television should not falsely trigger a battery test on the smoke detector.

When the IR Photo Diode Receiver is triggered it sends the filtered IR energy signal to the Control Unit. If the Control Unit is set to receive any IR energy it will immediately toggle the Test Battery signal. The Test Result is then sent to the Control Unit in either an analog or digital format.

An alternate embodiment of this invention will allow the infra red receiver to decode a specific series of infra red pulses if a specific smoke detector transmitter remote is employed. If the Control Unit is set to decode a set of IR pulses it will do so. Once the decoding is complete the Control Unit will then toggle the Test Battery Signal. The Test

Result is then sent to the Control unit in either an analog or digital format. The present invention then has the capability to output the result of the battery capacity/freshness test by either (1) blinking a Light Emitting Diode (LED) with varying rates or codes as to indicate the capacity of the battery, (2) digital numeric LED or Liquid Crystal Display (LCD) display, (3) enabling the audible alarm to perform a series of chirps as to the remaining battery capacity. To further explain (1) above if the user depresses a button on the remote control which starts the smoke detector battery test. At this point if the manufactured visual indicator is simply one LED the Control Unit will blink the LED at a rate which is indicative to remaining battery life. It is our claim that the most discernable blinking frequency to the average human is 1 Hz (hertz, one blink per second). So this is the chosen center-point. A fresh battery or battery with greater than 3 months of life remaining will blink at a rate faster than one hertz, 2-4 Hz works well. As we approach a battery life of three months (as determined by the Control Unit) the blinking rate will be near 1 Hz. This will indicate that the battery should be considered for replacement. As the battery capacity diminishes the blinking frequency shall be slower than 1 Hz. Blinking rates slow than 1 Hertz indicates a weakening battery with less than three months life remaining. A steady state LED tuned ON will indicate the battery should be immediately replaced. So a complete battery capacity result can be delivered to the user simply by a single LED blinking at a rate between 0 Hertz (ON) and 3 Hertz (blinking fast). Alternately the Control Unit may be set to blink a code as to battery life. For instance one blink indicates the battery must be replaced immediately, two blinks indicate approximately three months remaining, three or more blinks indicate a battery with more than three months remaining.

What is claimed is:

1. A method for indicating the remaining battery life of a smoke detector battery comprising:
any standard Television, DVD, VCR, Satellite, or Stereo Remote Controller which is able to transmit an Infrared (IR) signal by pressing a remote control button;
a remote IR photo diode receiver for detecting directed IR signals;
an IR sensitivity attenuation unit in the form of a lens and tube for the IR light to pass;
a Control Unit which will initiate a smoke detector battery capacity when receiving appropriate amount of IR energy,
a Control Unit which decodes battery test results and outputs information to a Visual Indicator.

2. The method for displaying the capacity of a smoke detector battery as claimed in claim 1, wherein the Control Unit determines the amount of battery life and outputs the information to an LED Visual Indicator as blinking at variable rates in the range of zero hertz to 4 hertz.

3. The method for displaying the capacity of a smoke detector battery as claimed in claim 1, wherein the Control Unit determines the amount of battery life and outputs the information to a numeric LED Visual Indicator or numeric LCD Visual Indicator.

4. The method for displaying the capacity of a smoke detector battery as claimed in claim 1, wherein the Control Unit determines the amount of battery life and outputs the information to an LED Visual Indicator as a blinking a variable number of times to indicate the remaining battery life.

5. The method for an audio transmission of the capacity of a smoke detector battery as claimed in claim 1, wherein the Control Unit determines the amount of battery life and outputs the information via a forced audio chirp as chirping a variable number of times to indicate the remaining battery life.

6. The method for triggering the battery life test as claimed in claim 1, where the triggering event is from an infrared remote control.

7. The method for receiving the IR signal as claimed in claim 1, wherein the IR energy from a remote is sufficient from the remote control key pressed to trigger the battery test regardless of the IR encoding.

8. The method for receiving the IR signal as claimed in claim 1, wherein the IR energy from sources of sunlight, incandescent light, florescent light, and LED lighting is filtered out.

9. The method for sensing the battery life as claimed in claim 1, wherein the Control Unit has stored the information of a number of previous battery tests to determine if the battery charge is deteriorating.

10. The method for sensing the battery life as claimed in claim 1, wherein the Battery Test Unit has the ability to place a light resistive load on the battery under test when taking the battery voltage measurement.

11. A system including an apparatus wherein the IR sensitivity attenuation is in the form of a small lens and tube for the infrared light to travel through.

12. A system using a blinking LED to issue a system state by either blinking the LED at a rate faster than 1 Hz (up to 4 Hz) or slower than 1 Hz (down to 0.25 Hz).
